(19) United States
(12) Patent Application Publication
(10) Pub. No.: US 2026/0176143 A1
(43) Pub. Date: Jun. 25, 2026

(54) Masterbatch Compositions Comprising Carbon Black and Graphene

(71) Applicant: BIRLA CARBON U.S.A., INC., Marietta, GA (US)

(72) Inventors: Saptarshi Kar, Mumbai (IN); Bikshan Ghoshi, Mumbai (IN); Abhijith Urumise, Mumbai (IN); Ranjan Ghosal, Mumbai (IN)

(21) Appl. No.: 19/129,185

(22) PCT Filed: Nov. 14, 2023
(86) PCT No.: PCT/US2023/079584

§ 371 Date: May 12, 2025

Related U.S. Application Data
(60) Provisional application No. 63/424,989, filed on Nov. 14, 2022.

(30) Foreign Application Priority Data
Nov. 17, 2022 (IN) 202211065851

(51) Int. Cl. C01B 32/194; C01B 32/184; C01B 32/192

(52) U.S. Cl. CPC C01B 32/194; C01B 32/184; C01B 32/192

(57) ABSTRACT

This disclosure relates generally to masterbatch compositions, and specifically to masterbatch compositions comprising carbon black or hybrid carbon black materials together with graphene, and to methods for making and using the same.

### CROSS-REFERENCE TO RELATED APPLICATIONS

This application claims priority to U.S. Provisional Application No. 63/424,989, filed Nov. 14, 2022, and Indian Application No. 202211065851, filed Nov. 17, 2022, both of which are incorporated into this application by reference.

### BACKGROUND

This disclosure relates generally to masterbatch compositions, and specifically to masterbatch compositions comprising carbon black or hybrid carbon black materials together with graphene, and to methods for making and using the same.

### TECHNICAL BACKGROUND

Graphenes are typically arranged as sheets of graphitic layers having a thickness of a few atoms and a lateral dimension in the order of a few microns depending on grade and the process used to manufacture them. Graphenes have a high surface energy. As a result, several graphene sheets tend to agglomerate together to form thick flakes in the solid state. Formation of such flakes makes it difficult to disperse graphenes in rubber. Thus, despite being a strong material, graphene typically will not improve rubber properties if mixed into rubber by conventional dry-stage mixing techniques. In addition, different graphenes tend to behave differently when dry-stage mixed into natural rubber. Accordingly, a need in the art exists for new methods for incorporating graphene into rubber. These needs and others are met by the present invention.

### SUMMARY

In accordance with the purpose(s) of the invention, as embodied and broadly described herein, this disclosure, in one aspect, relates to masterbatch compositions comprising carbon black or hybrid carbon black materials together with graphene, and to methods for making and using the same.

In one aspect, the method for preparing the masterbatch composition comprises: (a) contacting a carbon black, a graphene, water, and a surfactant to form a carbon black/graphene slurry; (b) contacting the carbon black/graphene slurry with a rubber solution comprising a rubber material; and (c) coagulating the rubber solution and carbon black/graphene slurry.

In a further aspect, the method for preparing a masterbatch composition comprises: (a) contacting a carbon black, water, and a first surfactant to form a carbon black slurry; (b) providing a graphene slurry; (c) contacting the carbon black slurry with the graphene slurry to provide a carbon black/graphene slurry; (d) contacting the carbon black/graphene slurry with a rubber solution comprising a rubber material; and (e) coagulating the rubber solution and carbon black/graphene slurry.

In one aspect, the masterbatch comprises: (a) a rubber; (b) a carbon black at a concentration of 20-59.9 phr; and (c) a graphene at a concentration of 0.1-10 phr.

Also disclosed are articles prepared from the disclosed masterbatch compositions.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawing, which is incorporated in and constitutes a part of this specification and together with the description, serves to explain the principles of the disclosure.

FIG. 1 is a process flow diagram illustrating exemplary methods of preparing natural-rubber latex masterbatch comprising carbon black and graphene.

FIG. 2 shows plots of tensile strength (in Mpa) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

FIG. 3 shows plots of modulus (in Mpa) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

FIG. 4 shows plots of tear strength (in N/mm²) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

FIG. 5 shows plots of rebound resilience (%) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

FIG. 6 shows plots of heat buildup (ΔT) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

FIG. 7 shows plots of abrasion loss (mm³) of masterbatches loaded with carbon black and varying amounts of graphene oxide (GO), reduced graphene oxide (RGO), graphene nanoplatelets having a surface area of 750 m²/g (GnP750) and graphene nanoplatelets having a surface area of 500 m²/g (GnP500).

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications (including ASTM methods) mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a graphene” includes mixtures of two or more fillers, or carbon nanotubes, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

The term “masterbatch” means a mixture of the base polymer and a high concentration of carbon filler and other optional additives such as dispersing additives, pigments, dyes, colorants, and the like.

The abbreviation “phr” refers to parts per hundred parts of rubber, as is typically used in the rubber industry to describe the relative amount of each ingredient in a composition.

A “carbon black” refers not only to carbon blacks but also to hybrid carbon black materials (e.g., surface-modified carbon blacks, encapsulated carbon blacks, and the like).

A “graphene” refers to any type of graphene material including without limitation a graphene oxide (GO), a reduced graphene oxide (RGO), a graphene nano-platelet (GnP) having any suitable surface area (e.g., 500-800 m²/g, such as for example, 500 m²/g or 750 m²/g), or a combination thereof.

Various analytical tests and values are recited herein to describe in-rubber properties of a rubber compound. Such tests and/or values are intended to refer to those tests and procedures typically used in the respective industry (e.g., rubber compounding and/or tire manufacture), or used as standard test procedures, such as, for example, ASTM D3192-09.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, conventional methods of dry-stage mixing graphenes as well as carbon blacks into natural rubber suffer from disadvantages arising from the difficulty in adequately dispersing the graphenes and carbon blacks into the matrix. Carbon blacks and graphenes are inherently difficult to disperse, particularly in elastomeric systems. Accordingly, there is a need to produce masterbatch compositions containing well-dispersed carbon black and graphenes. The disclosed masterbatch compositions can be introduced into a mixer and let-down or diluted with additional elastomer of the same of varying type relative to the base rubber polymer used in the masterbatch. Such masterbatch compositions can produce rubber and other elastomeric compounds having various mechanical properties.

### A. MASTERBATCH PREPARATION METHODS AND COMPOSITIONS

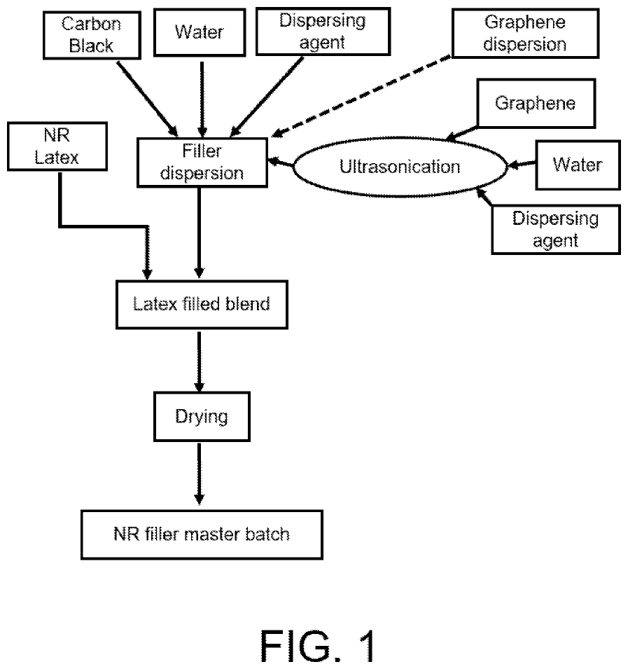

According to one aspect, with reference to the exemplary process flow diagram shown in FIG. 1, the disclosed masterbatches can be prepared according to two general methods. A carbon black slurry with various types of carbon blacks can be prepared according to the methods described in U.S. Patent Publication No. 2018/0371181, which is incorporated by reference in its entirety for its teaching of carbon black slurry and dispersion preparation methods. In general, an aqueous dispersion of carbon black or a carbon black hybrid material (e.g., surface-modified carbon blacks, encapsulated carbon blacks, and the like) with raw liquid latex. The methods can also be used with other carbon-based nanomaterials, including for example, graphene, carbon nanotubes (single and multi-walled) and in general are suitable for use with any type of particulate carbon, including with carbon blacks having surface modifications such as polymers grafted to the surface of the carbon black.

A graphene dispersion can be prepared according to at least two methods. In one aspect, graphene can be freshly-produced in an aqueous medium and added directly to a dispersion of carbon black. One advantage of the invention is that it was discovered that freshly-produced graphene in water is adequately dispersed such that it can be added directly to the carbon black dispersion without the need for further graphene dispersion. In another aspect, solid graphene can be mixed with water and a suitable dispersing agent such as an anionic surfactant and dispersed through a suitable method such as sonication or mixing (e.g., mixing for 1 hr). The resulting carbon black/graphene dispersion is referred to as the “filler dispersion” in FIG. 1. Although FIG. 1 depicts an exemplary process in which carbon black and graphene dispersions are prepared separately, then mixed together, the invention contemplates a process in which carbon black and graphene can be dispersed together in a single pot.

The filler dispersion comprising the carbon black and graphene can then be mixed with raw liquid latex to form the latex-filled blend. Upon coagulating and drying, the method affords a latex-filler masterbatch that can then be let-down to produce a variety of rubber-based materials. Used as an ingredient in a rubber compound formulation, this can facilitate efficient dispersion of carbon black and graphene into rubber, with lower energy of mixing in industrial scale rubber compounding processes. This general method can be used to prepare masterbatches with starting graphene materials including without limitation graphene oxide (graphene oxide powder), reduced graphene oxide (RGO), graphene nano-platelets, and graphene dispersions in water.

In one aspect, the inventive masterbatch composition can impart improved properties to a 25 rubber compound, such as, for example, tensile strength, modulus, tear strength, rebound resilience, heat buildup, abrasion loss, and the like. In some aspects, for example, the tensile strength, tear strength, and 300% modulus were improved by 10-40%. Similarly, the tan δ at 70° C. and the abrasion resistance can in some aspects be improved by 10-50%.

In another aspect, the inventive masterbatch composition can reduce and/or eliminate the need for high energy processing steps for an end user. In another aspect, the present invention can improve the ease with which rubber processors disperse carbon black and graphene in a compound. In yet another aspect, the present invention can improve the quality of rubber compounds containing carbon black and graphene. In still another aspect, the present invention can minimize and/or eliminate the requirement for pelletization of carbon black/graphene masterbatches.

The steps of the disclosed method for preparing a carbon-black/graphene/rubber masterbatch can include: obtaining and/or preparing a well-dispersed slurry of carbon black in water, and obtaining and/or preparing a well-dispersed slurry of a graphene in water. In some aspects, these steps can be performed together, i.e., the carbon black and graphene can be obtained or prepared together as a well-dispersed slurry of carbon black/graphene in water. Alternatively, in other aspects, these steps can be performed separately such that the carbon black slurry is obtained or prepared separately from the graphene slurry.

In general, the aqueous dispersion can comprising 0.1-20% by weight of carbon black, while graphene can also be present in the aqueous dispersion at a weight percent of 0.1-20% by weight. In some aspects, the slurry can comprise 0.1-10% graphene by weight, e.g., 0.1-8%, 0.1-6%, 0.1-5%, 0.1-3%, or 0.1-2% by weight. In further aspects, the slurry can comprise 0.1-15% carbon black by weight, e.g., 0.1-12%, 0.1-11%, 0.1-10%. In a specific aspect, the slurry can comprise about 10% by weight carbon black.

The ratio of carbon black and graphene in the slurry can be at any proportion subject to the desired final loading of carbon black and graphene in the masterbatch.

In some aspects, the graphene slurry can be prepared by freshly-producing graphene in situ in water (or obtaining the graphene slurry in this form from a suitable commercial source) and directly adding this mixture to a slurry of carbon black. In other aspects, the graphene slurry can be prepared by contacting a solid graphene with water and a surfactant at suitable ratios and dispersing the graphene in the water with a technique such as ultrasonification or mixing.

Once the carbon black/graphene slurry has been prepared, it can be mixed with liquid latex. Finally, the slurry-latex mixture can be coagulated and dewatered to obtain a solid masterbatch. Since the viscosity of the carbon black/graphene dispersion is an important parameter in determining the quality of the final masterbatch, the inventive methods include the use of one or more surfactants to enhance the dispersion of carbon black and/or in water. In addition, coagulation of the mixture can be optimized by varying the pH and temperature of the mixture.

In various aspects, the invention comprises preparation of an aqueous dispersion of carbon black either together or separately from the aqueous dispersion of graphene. The carbon black can comprise any suitable carbon black for preparing a masterbatch with a natural rubber latex. In one aspect, the carbon black comprises a carbon black produced by the furnace process. In another aspect, the carbon black comprises a rubber grade carbon black or a carbon black suitable for compounding into an elastomer system. In another aspect, the carbon black comprises an ASTM grade carbon black suitable for use in a rubber compound. In another aspect, the carbon black can comprise a mixture of one or more carbon blacks having similar or differing colloidal properties. In yet another aspect, the carbon black can comprise a tread grade carbon black and/or a carcass grade carbon black. In yet another aspect, the carbon black can comprise a pelletized or an unpelletized (i.e., powdered) carbon black. In yet another aspect, the carbon black can comprise a N234 grade carbon black. In various aspects, the carbon black comprises an N234 grade carbon black, available from SKI Carbon Black (India) Pvt Ltd, Aditya Birla Centre, S. K. Ahire Marg, Worli, Mumbai—400030, Maharashtra, India.

In other various aspects, the invention comprises preparation of an aqueous dispersion of a graphene either together or separately from the carbon black dispersion. A variety of graphenes can be used. Non-limiting examples include graphene oxide (GO), reduced graphene oxide (RGO), a graphene nanoplatelet (GnP) having a suitable surface area (e.g., 500-800 m²/g, such as for example, 500 m²/g or 750 m²/g), or a combination thereof.

In some aspects, it can be useful to incorporate a graphene having a certain lateral dimension and number of surface flaws. In one aspect, it was found that graphenes having a low lateral dimension and more surface flaws reinforce better with the rubber matrix, allowing significant mechanical property enhancement over conventional dry-stage mixing methods. In general, the graphene can have an average lateral dimension of about 2-60 microns. In other aspects, the graphene has a high lateral dimension (e.g., up to 60 microns). In still other aspects, the graphene has a low lateral dimension (e.g., about 5-10 microns). In yet other aspects, the graphene as an ultra-low lateral dimension (e.g., about 2-5 microns).

In various aspects, it is contemplated that the aqueous dispersion of carbon black and/or graphene is a stable, aqueous dispersion. In another aspect, the dispersion comprises an pelleted and powdered carbon black. One or more surfactants can be used to stabilize the carbon black and/or graphene dispersions. The surfactant should be able to stabilize a carbon black and/or graphene slurry and allow the production of a good dispersion. In another aspect, the surfactant should not adversely affect the process of mixing the carbon black slurry and/or graphene slurry with a natural latex solution or composition. In yet another aspect, the surfactant should not adversely affect a subsequent coagulation step. In still another aspect, the surfactant should provide the desired properties and dispersion at low concentrations in water.

Thus, the surfactant can comprise any surfactant suitable for use with the present invention. The surfactant can comprise a nonionic surfactant, an ionic surfactant, such as, for example, an anionic surfactant and/or a cationic surfactant, and/or a combination thereof. In one aspect, the surfactant comprises a non-ionic surfactant. In another aspect, the surfactant comprises an anionic surfactant. In various aspects, the surfactant can comprise TERGITOL brand surfactant, such as, for example, TERGITOL 15 S 30, available from Sigma Aldrich. In yet another aspect, the surfactant can comprise TAMOL brand surfactant, such as, for example, TAMOL NN9104, available from BASF. In other aspects, the surfactant can comprise one or more surfactants not specifically recited herein. The surfactant used to disperse the carbon black can be the same or different as the surfactant used to disperse the graphene (in instances in which the graphene dispersion is not prepared directly in situ in an aqueous medium).

In another aspect, the invention comprises preparation of a rubber composition, such as, for example, a stabilized natural rubber latex. The methods of the present invention can also be used with other rubber materials, such as, for example, a synthetic latex, a styrene-butadiene rubber, or other rubber materials commonly used in the manufactured rubber goods and tire industries. It should be appreciated that any recitation herein regarding a natural rubber latex is also intended to include aspects where one or more other rubber materials are used in addition to or in lieu of the recited natural rubber latex. It should also be appreciated that the use of other rubber materials can require modifications to the mixing times, ratios, etc., but one of ordinary skill in the art would readily be able to make such modifications in view of the teachings of this disclosure. In one aspect, the natural rubber latex of the present invention can comprise a 60% natural rubber latex, for example, 60% Cenex, available from Harrison Malayalam Limited 24/624, Bristow Road, Willingdon Island, Cochin 682003, Kerala, India.

In yet another aspect, the invention comprises coagulation by, for example, various means, to recover a portion of the solid components of the mixture as a homogeneous phase of rubber and carbon black/graphene. In one aspect, the coagulation is a controlled coagulation of the masterbatch composition and can occur either with or without the use of a chemical agent. Such a controlled coagulation can facilitate the separation of serum and rubber components.

In one aspect, a mixture of the aqueous slurry of carbon black/graphene and natural rubber latex, such as, for example, an alkali-NR latex, can be coagulated using an acid, after which the coagulated product can be separated by, for example, filtration, and then optionally be dried. In another aspect, a mixture of the aqueous slurry of carbon black/graphene and natural rubber latex can be coagulated using heat treatment, after which the coagulated product can be separated by, for example, filtration, and then optionally be dried. In other aspects, other coagulation agents known and/or used in the rubber industry can be utilized in addition to or instead of an acid.

In one aspect, a natural rubber latex carbon black/graphene masterbatch can be prepared, followed by coagulation with an acid, such as, for example, formic acid, citric acid, acetic acid, or sulfuric acid. In one aspect, the acid can comprise an organic acid. In another aspect, the acid can comprise an inorganic acid. In a specific aspect, the acid comprises formic acid. It should be understood that any acid suitable for use in coagulating rubber compounds can be used, and any recitation herein describing an acid, such as formic acid, is intended to include aspects, wherein other aspects are used in addition to or in lieu of the recited acid. In such an aspect, a natural rubber latex solution can be prepared separate from the preparation of a carbon black slurry. The natural rubber latex solution and the carbon black/graphene slurry can then be contacted, for example, mixed. The mixed composition can then be coagulated and dried to form a masterbatch composition. The concentration of acid utilized to coagulate a rubber solution and carbon black/graphene slurry can vary, and one of ordinary skill in the art, in possession of this disclosure, could readily determine an appropriate amount of acid to use for a coagulation process.

In another aspect, the present invention and the methods described herein can be performed without the need for high energy mixers, such as those traditionally used to disperse carbon blacks into rubber materials. In another aspect, the present invention facilitates a reduction or elimination of chemicals typically used in the dispersion and masterbatch manufacturing process. In another aspect, the inventive carbon black/graphene/latex masterbatch composition can provide improved compound properties over conventional mixing techniques and compositions.

The carbon black/graphene/latex masterbatch composition of the present invention can be useful in the rubber products industry, including, for example, tires, manufactured rubber goods (MRG), and specialty rubber applications.

Thus, in various aspects, the methods of the present invention can provide a masterbatch having a total filler (carbon black plus graphene) loading ranging from about 30-60 phr. For example, the total filler loading can be 35, 40, 45, 50, 55, or 60 phr. A minority portion of the filler will in general be graphene. For example, the masterbatches can comprise 0.1-10 phr graphene loading, with the balance filler loading being comprised of carbon black. In some aspects, the masterbatch comprises 1-3 phr graphene loading with the balance of the filler loading being comprised of carbon black. In a further aspect, the masterbatch comprises 1 phr graphene loading with the balance of the filler loading being comprised of carbon black. It should be appreciated that concentration or any components recited in any of the methods described herein can be adjusted to provide a desired carbon black/graphene loading in the masterbatch.

Any of the inventive masterbatch compositions described herein can be utilized in the preparation of a rubber compound. In one aspect, the inventive masterbatch can be compounded according to ASTM D3192-09 (2014) by, for example, diluting with CV60 to bring the carbon black/graphene phr to within the range of 30-60 phr. When compared against a reference preparing by mixing pelleted ASTM N234 grade carbon black/graphene in CV60 using the conventional ASTM D3192-09 recipe, mixing time for the inventive masterbatch can be significantly reduced due to the improved carbon black/graphene dispersion. The inventive masterbatch compositions can also be let-down or diluted with one or more rubber compositions (e.g., synthetic rubber latex, styrene butadiene rubber) to produce a final rubber compound.

### B. EXAMPLES

Various exemplary embodiments of the invention are detailed below. These embodiments are intended to be exemplary and are not intended to limit the scope of the invention.

### 1. General Methods for Preparing Masterbatches

With reference to the exemplary process flow diagram shown in FIG. 1, the disclosed masterbatches can be prepared in some aspects according to two general methods. A carbon black slurry with various types of carbon blacks can be prepared according to the methods described in U.S. Patent Publication No. 2018/0371181, which is incorporated by reference in its entirety for its teaching of carbon black slurry and dispersion preparation methods. In general, carbon black at a desired loading can be dispersed in water with a dispersing agent to prepare the carbon black slurry. The dispersing agent can in general be any suitable anionic surfactant.

Graphene can be introduced into the filler dispersion through at least two different ways. First, in one aspect, graphene-oxide can be freshly produced in an aqueous medium (or obtained commercially in this form) and introduced directly into the carbon black slurry, without the need to redisperse the graphene in the aqueous medium. Second, and alternatively, solid graphene can be added to water along with a dispersing agent (such as an anionic surfactant) and separately ultrasonicated, sonicated, mixed, or dispersed through another suitable technique (e.g., mixed for 1 hr). The resulting graphene dispersion can then be added to the carbon black slurry prepared according to the general methods described in U.S. Patent Publication No. 2018/0371181. Similarly, in some aspects, the carbon black and graphene dispersions can be prepared together in one pot. This general method can be used to prepare masterbatches with starting graphene materials including without limitation graphene oxide (graphene oxide powder), reduced graphene oxide (RGO), graphene nano-platelets, and graphene dispersions in water.

The resulting filler dispersion, comprising carbon black and graphene, can then be added to a suitable amount of natural-rubber latex to prepare a latex-filled blend. The latex-filled blend can be dried to form the natural-rubber filler masterbatch.

More specifically, an aqueous dispersion of graphene can be prepared (or obtained commercially and diluted as desired) by mixing the aqueous slurry for about 1 hour, e.g., with a concentration of graphene in the slurry of about 0.1-20% by weight of the slurry. Surfactant can be added to aid in dispersion in the amount of 0.1-10% by weight of graphene in the slurry. It should be understood however that such graphene dispersion steps are not necessary when using a pre-dispersed graphene slurry received commercially. The dispersion of graphene can then be transferred to a suitable mixer. Separately or together with the graphene dispersion, the aqueous dispersion of carbon black can be prepared. In general, a mixing time of about 5-20 minutes is sufficient to form a dispersion having 0.1-10% by weight of carbon black. Optionally, a surfactant can be added to aid in the dispersion of the carbon black, generally in an amount ranging from 0.1-10% by weight of carbon black. The carbon black/graphene slurry can then be mixed with natural rubber latex. The latex and slurry mixture can be transferred to a coagulation tank simultaneously, mixed, then coagulated in a step that can take from about 5 to 20 minutes. Finally, the masterbatch can be dewatered in a centrifuge for 5-20 minutes at 500-2,000 rpm. The dewatered material can then be dried in a hot air oven for 5-10 hours at 70-90° C. to remove excess water.

2. Comparison of Mechanical Properties with Various Preparation Techniques and Types of Graphene Materials

Four masterbatches were prepared to compare mechanical properties observed through various mixing techniques. Mechanical properties of the resulting masterbatches are shown in Table 1. The masterbatches included 30 phr filler loading (with 25 phr carbon black and 5 phr graphene replacement).

TABLE 1
Mechanical Properties with Different Mixing Techniques (Graphene Oxide)

| | Tensile | Modulus | Hardness | Tear | Rebound | Heat | Abrasion |
|---|---|---|---|---|---|---|---|
| | Strength | (300%) | (Shore A) | Strength | resilience | Buildup | Resistance |
| CB + GO | 26.4 | 9.8 | 58 | 46.3 | 69.5 | 9 | 142 |
| CB + GO | 27.8 | 10.8 | 58 | 60.9 | 71.2 | 7 | 137 |
| (Latex- | | | | | | | |
| Sonicated) | | | | | | | |
| CB + GO | 24.8 | 6.8 | 53 | 47.7 | 64 | 8 | 141 |
| (Dry) | | | | | | | |
| CB + GO | 26.8 | 8.5 | 55 | 56.2 | 72.1 | 8 | 131 |
| (Latex + Dry | | | | | | | |

Four similar masterbatches were prepared with carbon black and graphene-nanoplatelets (GnP750, surface area 750 m²/g). The masterbatches included 30 phr total filler loading with 25 phr carbon black and 5 phr GnP750 replacement. Mechanical properties of the masterbatches are shown in Table 2.

TABLE 2
Mechanical Properties with Different Mixing Techniques (Graphene Nanoplatelet)

| | Tensile | Modulus | Hardness | Tear | Rebound | Heat | Abrasion |
|---|---|---|---|---|---|---|---|
| | Strength | (300%) | (Shore A) | Strength | resilience | Buildup | Resistance |
| CB + GnP750 | 28.7 | 8.2 | 54 | 64.1 | 67 | 8 | 121 |
| (Latex) | | | | | | | |
| CB + GnP750 | 31.5 | 9.3 | 54 | 82.2 | 69.8 | 8 | 119 |
| (Latex- | | | | | | | |
| Sonicated) | | | | | | | |
| CB + GnP750 | 22.8 | 7.2 | 50 | 44.1 | 61.3 | 10 | 128 |
| (Dry) | | | | | | | |
| CB + GnP | 28.9 | 7.5 | 52 | 56.5 | 65.2 | 9 | 133 |
| (Latex + Dry | | | | | | | |

Three masterbatches were similarly prepared with carbon black and reduced graphene oxide (RGO). The masterbatches included 30 phr total filler loading with 25 phr carbon black and 5 phr RGO replacement. Mechanical properties of the masterbatches are shown in Table3.

TABLE 3
Mechanical Properties with Different Mixing Techniques (RGO)

| | Tensile | Modulus | Hardness | Tear | Rebound | Heat | Abrasion |
|---|---|---|---|---|---|---|---|
| | Strength | (300%) | (Shore A) | Strength | resilience | Buildup | Resistance |
| CB + RGO | 30.6 | 6.9 | 54 | 47.1 | 68.7 | 8 | 138 |
| (Latex) | | | | | | | |
| CB + RGO | 30.4 | 8.1 | 53 | 47 | 70.5 | 8 | — |
| (Latex- | | | | | | | |
| Sonicated) | | | | | | | |
| CB + RGO | 24.2 | 6.7 | 52 | 46.7 | 62.3 | 11 | 137 |
| (Dry) | | | | | | | |

Three masterbatches were prepared with carbon black and graphene-nanoplatelets (GnP500, surface area 500 m²/g). The masterbatches included 30 phr total filler loading with 25 phr carbon black and 5 phr GnP500 replacement. Mechanical properties of the masterbatches are shown in Table 4.

TABLE 4
Mechanical Properties with Different Mixing Techniques (GnP500)

| | Tensile | Modulus | Hardness | Tear | Rebound | Heat | Abrasion |
|---|---|---|---|---|---|---|---|
| | Strength | (300%) | (Shore A) | Strength | resilience | Buildup | Resistance |
| CB + GnP500 | 30.8 | 8.4 | 54 | 63.9 | 66.8 | 8 | 127 |
| (Latex) | | | | | | | |
| CB + GnP500 | 30.7 | 9.4 | 54 | 56.8 | 69.7 | 8 | 121 |
| (Latex- | | | | | | | |
| Sonicated) | | | | | | | |
| CB + GnP500 | 20.5 | 7.1 | 50 | 50.7 | 60.4 | 10 | 127 |
| (Dry) | | | | | | | |

In general, studies of the mechanical properties of the masterbatches shown in Tables 1-4 demonstrate that a latex-sonicated mixing method is an efficient method of mixing graphene in rubber to obtain balanced mechanical properties.

### 3. Comparison of Graphene Loadings

Mechanical Properties of Masterbatches were Evaluated According to Different Amounts of Graphene Loading. The Samples Tested are Shown in Table 5.

TABLE 5
Samples Having Different Amounts of Graphene

| Total | Graphene | |
|---|---|---|
| Filler | Replacement | |
| Loading | Level | Description |
| 45 phr | 1 phr | 1 phr replacement of carbon black by |
| | | GO/RGO/GnP 750/GnP 500 |
| 45 phr | 3 phr | 3 phr replacement of carbon black by |
| | | GO/RGO/GnP 750/GnP 500 |
| 45 phr | 5 phr | 5 phr replacement of carbon black by |
| | | GO/RGO/GnP 750/GnP 500 |
| 45 phr | 7 phr | 7 phr replacement of carbon black by |
| | | GO/RGO/GnP 750/GnP 500 |

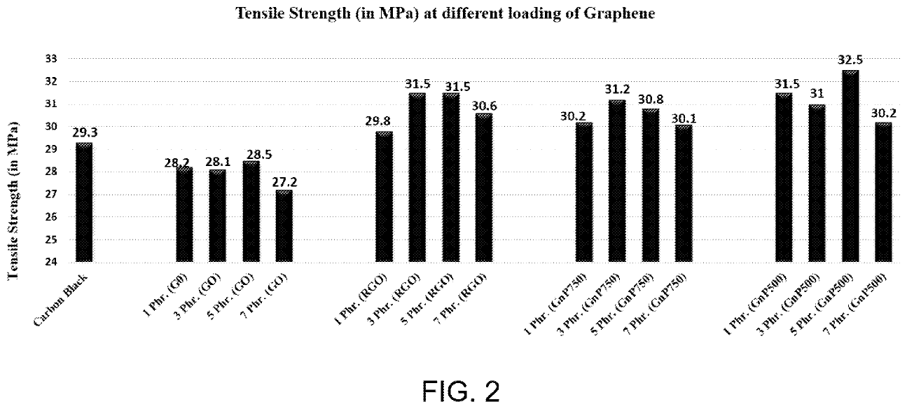

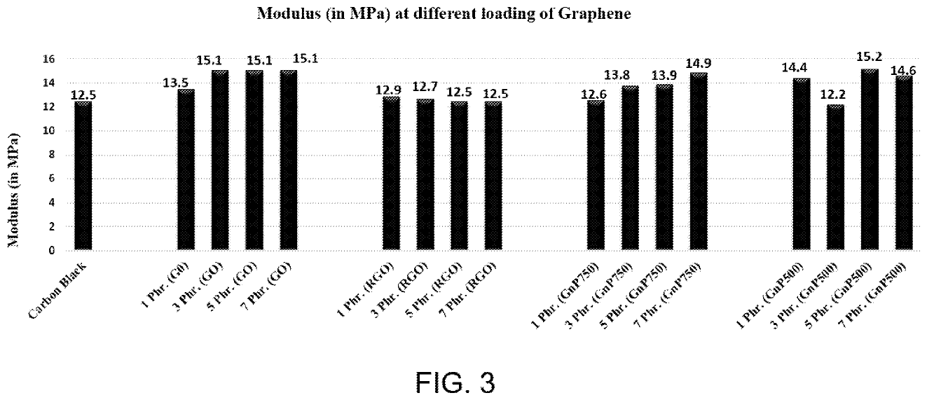

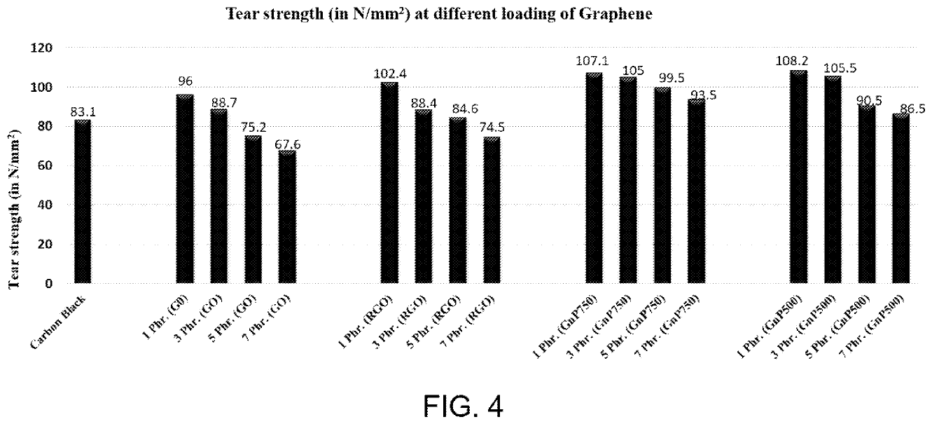

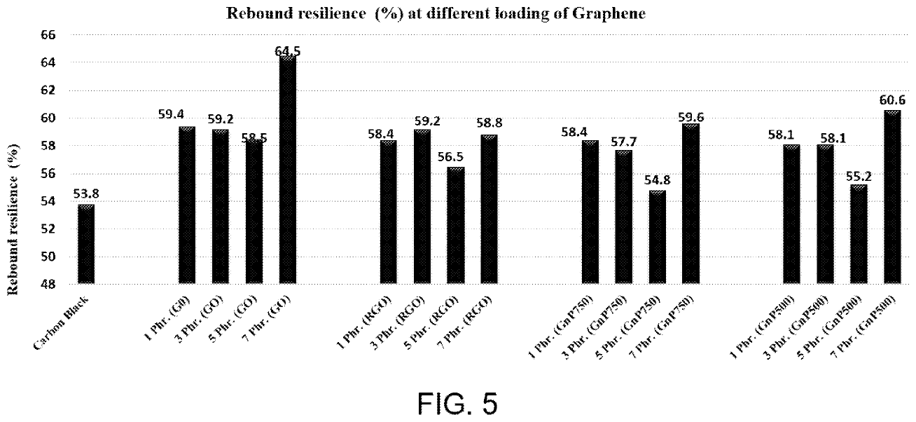

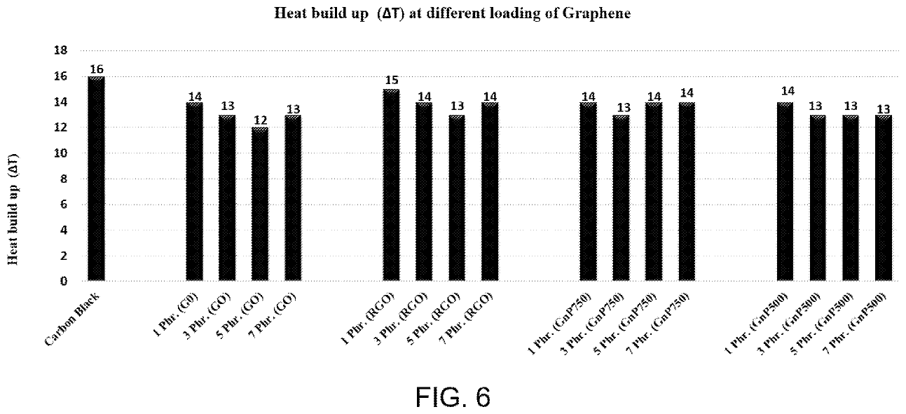

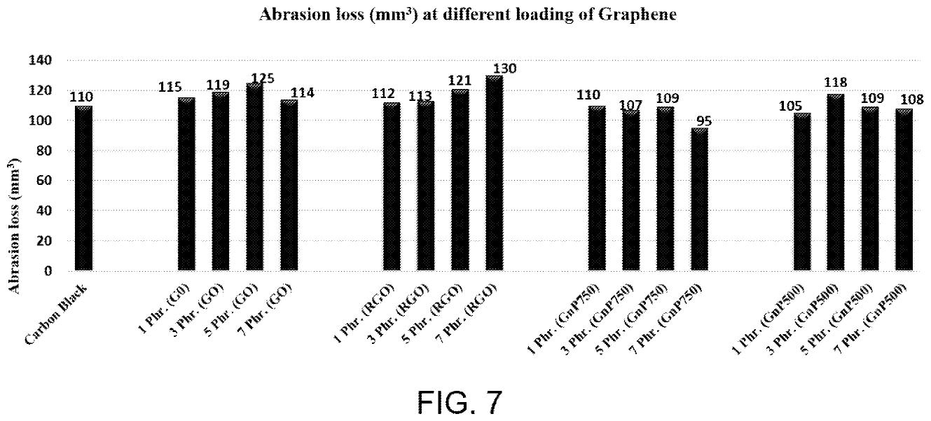

Results of mechanical property testing are shown in FIGS. 2-7. In general the studies indicate that graphene loadings as low as 1 phr are sufficient to impart balanced mechanical properties for the masterbatches.

### 4. Effect of Lateral Graphene Dimension

To compare effects of lateral graphene dimensions, a freshly prepared graphene slurry was prepared as described above and added directly into a natural-rubber latex along with carbon black. The total filler loading was 45 phr with 1 phr graphene replacement level. Three different graphenes with different lateral dimensions were evaluated: (1) high lateral dimension graphene oxide (lateral dimension about 50 microns), (2) low lateral dimension graphene oxide (lateral dimension about 5-10 microns), and (3) ultra low lateral dimension graphene oxide (lateral dimension about 2-3 microns). A comparison of rubber properties from these masterbatches is shown in Table 6.

TABLE 6
Comparison of Rubber Properties

| | | CB + High | CB + Low | CB + Ultra |
|---|---|---|---|---|
| | | lateral | lateral | low lateral |
| | | dimension | dimension | dimension |
| | CB | Graphene | Graphene | Graphene |
| | (45 | oxide | oxide | oxide |
| Sample | phr) | (44 + 1 phr) | (44 + 1 phr) | (44 + 1 phr) |
| Modulus @ 300% | 13.1 | 14.8 | 16.3 | 16.4 |
| (MPa) | | | | |
| Tensile Strength | 26.8 | 25.7 | 30.1 | 27.2 |
| (MPa) | | | | |
| Elongation at Break | 488 | 454 | 493 | 457 |
| (%) | | | | |
| Tear Strength | 101.4 | 97.9 | 114.4 | 85.9 |
| (N/mm²) | | | | |
| Hardness (Shore A) | 62 | 67 | 63 | 64 |
| Rebound resilience | 59.25 | 59.30 | 59.5 | 59.1 |
| (%) | | | | |
| Abrasion loss | 140 | 151 | 123 | 126 |
| (mm³) | | | | |
| Heat build up (ΔT) | 17 | 16 | 14 | 13 |
| Mooney viscosity | 68.2 | 72.6 | 76.9 | 72 |
| ML(1 + 4)@100° | | | | |
| C. | | | | |

In general, the results in Table 6 indicate that rubber properties can be tuned with the graphene oxides having different lateral dimensions and that low lateral dimension graphene oxide provides useful rubber properties.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for preparing a masterbatch composition, the method comprising:
a) contacting a carbon black, a graphene, water, and a surfactant to form a carbon black/graphene slurry;
b) contacting the carbon black/graphene slurry with a rubber solution comprising a rubber material; and
c) coagulating the rubber solution and carbon black/graphene slurry.

2. The method of claim 1, wherein the masterbatch comprises the carbon black and the graphene at a total filler concentration of 30-60 phr with the graphene concentration being 0.1-10 phr.

3. The method of claim 1, wherein the graphene is graphene oxide, reduced graphene oxide, graphene nano-platelets, or a combination thereof.

4. The method of claim 1, wherein the graphene has an average lateral dimension of 2-60 microns.

5. The method of claim 1, wherein the graphene has an average lateral dimension of 2-5 microns.

6. A method for preparing a masterbatch composition, the method comprising:
a) contacting a carbon black, water, and a first surfactant to form a carbon black slurry;
b) providing a graphene slurry;
c) contacting the carbon black slurry with the graphene slurry to provide a carbon black/graphene slurry;
d) contacting the carbon black/graphene slurry with a rubber solution comprising a rubber material; and
e) coagulating the rubber solution and carbon black/graphene slurry.

7. The method of claim 6, wherein when step (b)(ii) is performed, the ratio of the graphene to the second surfactant is about 1:0.05.

8. The method of claim 6, wherein when step (b)(ii) is performed, the ratio of water to the graphene is about 10:1.

9. The method of claim 6, wherein when step (b)(ii) is performed, contacting comprises ultrasonification.

10. The method of claim 6, wherein the masterbatch comprises the carbon black and the graphene at a total filler concentration of 30-60 phr with the graphene concentration being 0.1-10 phr.

11. The method of claim 6, wherein the graphene is graphene oxide, reduced graphene oxide, graphene nano-platelets, or a combination thereof.

12. The method of claim 6, wherein the graphene has an average lateral dimension of 2-60 microns.

13. The method of claim 6, wherein the graphene has an average lateral dimension of 2-5 microns.

14. A masterbatch comprising:
a) a rubber;
b) a carbon black at a concentration of 20-59.9 phr;
c) a graphene at a concentration of 0.1-10 phr.

15. The masterbatch of claim 14, wherein the graphene is graphene oxide, reduced graphene oxide, graphene nano-platelets, or a combination thereof.

16. The masterbatch of claim 14, wherein the graphene has an average lateral dimension of 2-60 microns.

17. The masterbatch of claim 14, wherein the graphene has an average lateral dimension of 2-5 microns.
